(19) United States
(12) Patent Application Publication
(10) Pub. No.: US 2021/0150378 A1
(43) Pub. Date: May 20, 2021

(54) RECOMMENDATION METHOD, RECOMMENDATION APPARATUS, RECOMMENDATION DEVICE, RECOMMENDATION SYSTEM AND STORAGE MEDIUM

(71) Applicant: BOE TECHNOLOGY GROUP CO., LTD., Beijing (CN)

(72) Inventors: Guohe WANG, Beijing (CN); Zhengong ZHAO, Beijing (CN)

(73) Assignee: BOE TECHNOLOGY GROUP CO., LTD., Beijing (CN)

(21) Appl. No.: 16/623,207

(22) PCT Filed: Apr. 10, 2019
(86) PCT No.: PCT/CN2019/082116

§ 371 Date: Dec. 16, 2019

(30) Foreign Application Priority Data
Apr. 12, 2018 (CN) 201810328518.6

(51) Int. Cl. G06N 5/04; G06N 5/02; G06F 16/9535; G06Q 30/06

(52) U.S. Cl. CPC G06N 5/04; G06Q 30/0631; G06F 16/9535; G06N 5/02

(57) ABSTRACT

A recommendation method, a recommendation apparatus, a recommendation device, a recommendation system and a storage medium. The recommendation method includes: acquiring user behavior information related to at least one object to be recommended; on the basis of the user behavior information, calculating a preference value of the user for the at least one object to be recommended, and constructing a preference matrix of the user for the at least one object to be recommended; on the basis of the preference matrix, acquiring a predicted preference value of the user for at least one object to be recommended of an unknown preference, and providing a recommendation parameter on the basis of the predicted preference value.

The present application is based on PCT/CN2019/082116, filed on Apr. 10, 2019, and claims priority of the Chinese Patent Application No. 201810328518.6, filed on Apr. 12, 2018, the entire disclosure of which is incorporated herein by reference as part of the present application.

### TECHNICAL FIELD

Some embodiments of the present disclosure relate to a recommendation method, a recommendation apparatus, a recommendation device, a recommendation system and a storage medium.

### BACKGROUND

The development of science and technology and the Internet are pushing forward the advent of the big data era. Every day, a large number of data fragments are generated in all walks of life. Data measurement units have developed from Byte, KB, MB, GB and TB to PB, EB, ZB, YB and even BB, NB and DB. For example, big data can be applied to all walks of life. By analyzing and collating huge data collected by people, effective use of information can be realized.

### SUMMARY

At least one embodiment of the present disclosure provides a recommendation method, which includes: acquiring user behavior information related to at least one object to be recommended; acquiring a preference value of a user for the at least one object to be recommended according to respective user behavior information, and constructing a preference matrix of the user for the at least one object to be recommended; and acquiring a predicted preference value of the user for each object to be recommended with unknown preference based on a preference matrix, and providing a recommendation parameter according to the predicted preference value.

For example, in the recommendation method provided by an embodiment of the present disclosure, the user behavior information comprises single behavior information or combined behavior information. The single behavior information comprises behavior information generated by the user by operating a type of smart terminal; and the combined behavior information comprises behavior information generated by the user by operating at least two types of smart terminals.

For example, in the recommendation method provided by an embodiment of the present disclosure, the preference matrix is decomposed by a collaborative filtering method, so as to output the predicted preference value of the user for each object to be recommended with unknown preference.

For example, in the recommendation method provided by an embodiment of the present disclosure, acquiring the user behavior information related to the at least one object to be recommended, comprises: acquiring single behavior information from a first terminal, in which single behavior information of the first terminal comprises browsing behaviors, searching behaviors, purchasing behaviors, non-purchasing behaviors, sharing behaviors and pushing behaviors; acquiring single behavior information from a second terminal, in which single behavior information of the second terminal comprises playing behaviors; and acquiring combined behavior information from the first terminal and the second terminal respectively, in which the combined behavior information comprises purchasing behaviors or non-purchasing behaviors implemented by the user after an object to be recommended, pushed from the first terminal to the second terminal, is previewed on the second terminal by the user.

For example, in the recommendation method provided by an embodiment of the present disclosure, acquiring the preference value of the user for the at least one object to be recommended according to respective user behavior information, and constructing the preference matrix of the user for the at least one object to be recommended, comprises: calculating a preference value of a user i for an object j to be recommended by weighting user behavior information of the user i for the object j to be recommended. And a calculation method of a preference value wᵢⱼ of the user i for the object j to be recommended is as follows:

wᵢⱼ=Σₖ₌₁^{L}aₖrₖ (1)

where aₖ is a weight of a k^{th} type of user behavior; rₖ represents whether the kth type of user behavior occurs or not, if occurs, rₖ takes 1, otherwise, rₖ takes 0; 1≤k≤L, L is a count of behavior types, and L is an integer greater than 1; and i and j are both integers greater than or equal to 1.

For example, in the recommendation method provided by an embodiment of the present disclosure, for different behavior types, weights of the different behavior types are determined according to a count of behaviors, a price coefficient and a cost coefficient. Each of the behavior types is set with a corresponding single behavior weight.

For example, in the recommendation method provided by an embodiment of the present disclosure, when a behavior type is a purchasing behavior, a weight of the purchasing behavior is calculated as follows:

weight=single behavior weight×count of behaviors×price coefficient;

when the behavior type is a non-purchasing behavior, a weight of the non-purchasing is calculated as follows:

weight=single behavior weight×cost coefficient; and

as for other behavior types, a weight of the other behavior types is calculated as follows:

weight=single behavior weight×count of behaviors.

For example, in the recommendation method provided by an embodiment of the present disclosure, the price coefficient is determined according to a price of a current object to be recommended, a minimum value among prices of all objects to be recommended, and a maximum value among prices of all objects to be recommended. The price coefficient is calculated as follows:

price coefficient=(price of current object to be recommended−minimum value of prices of all objects to be recommended)÷(maximum value among prices of all objects to be recommended−minimum value of prices of all objects to be recommended)+1.

For example, in the recommendation method provided by an embodiment of the present disclosure, a relationship between the cost coefficient and the price coefficient is as follows:

cost coefficient=1/price coefficient.

For example, in the recommendation method provided by an embodiment of the present disclosure, acquiring a predicted preference value of the user for an object to be recommended with unknown preference based on the preference matrix and providing the recommendation parameter according to the predicted preference value, comprises: sorting predicted preference values of the user i for all objects to be recommended with unknown preference, and recommending top N objects to be recommended with the predicted preference values sorted from large to small or objects to be recommended with the predicted preference values larger than a set value to the user i; and N is an integer greater than or equal to 1.

For example, in the recommendation method provided by an embodiment of the present disclosure, the preference matrix is a two-dimensional preference matrix.

For example, in the recommendation method provided by an embodiment of the present disclosure, the object to be recommended comprises a painting.

At least one embodiment of the present disclosure further provides a recommendation apparatus, which includes an acquisition unit, a matrix construction unit and an output unit. The acquisition unit is configured to acquire user behavior information related to at least one object to be recommended; the matrix construction unit is configured to calculate a preference value of a user for the at least one object to be recommended according to respective user behavior information, and construct a preference matrix of the user for the at least one object to be recommended; and the output unit is configured to acquire a predicted preference value of the user for each object to be recommended with unknown preference based on the preference matrix, and provide a recommendation parameter according to the predicted preference value.

For example, in the recommendation apparatus provided by an embodiment of the present disclosure, the acquisition unit comprises: a first acquisition subunit, a second acquisition subunit and a combined behavior acquisition subunit. The first acquisition subunit is configured to acquire single behavior information from a first terminal, and single behavior information of the first terminal comprises browsing behaviors, searching behaviors, purchasing behaviors, non-purchasing behaviors, sharing behaviors and pushing behaviors; the second acquisition subunit is configured to acquire single behavior information from a second terminal, and single behavior information of the second terminal comprises playing behaviors; and the combined behavior acquisition subunit is configured to acquire combined behavior information from the first terminal and the second terminal respectively, and the combined behavior information comprises non-purchasing behaviors or purchasing behaviors implemented by the user after an object to be recommended, pushed from the first terminal to the second terminal, is previewed on the second terminal by the user.

For example, in the recommendation apparatus provided by an embodiment of the present disclosure, the output unit comprises a calculation unit. The calculation unit is configured to weight and calculate user behavior information of a user i for an object j to be recommended, so as to obtain a preference value of the user i for the object j to be recommended.

A calculation method of a preference value wᵢⱼ of the user i for the object j to be recommended is as follows:

wᵢⱼ=Σₖ₌₁^{L}aₖrₖ (1)

where aₖ is a weight of a kth type of user behavior; rₖ represents whether the kth type of user behavior occurs or not, if occurs, rₖ takes 1, otherwise, rₖ takes 0; 1≤k≤L, L is a count of behavior types, L is an integer greater than 1, and i and j are both integers greater than or equal to 1.

For example, in the recommendation apparatus provided by an embodiment of the present disclosure, the calculation unit comprises a weight determining unit. The weight determining unit is configured to, for different behavior types, determine weights of the different behavior types according to single behavior weight, a count of behaviors, a price coefficient and a cost coefficient, and each of the behavior types is set with a corresponding single behavior weight.

For example, in the recommendation apparatus provided by an embodiment of the present disclosure, when a behavior type is a purchasing behavior, a weight of the purchasing behavior is calculated as follows:

weight=single behavior weight×count of behaviors×price coefficient;

when the behavior type is a non-purchasing behavior, a weight of the non-purchasing is calculated as follows:

weight=single behavior weight×cost coefficient; and

as for other behavior types, a weight of the other behavior types is calculated as follows:

weight=single behavior weight×count of behaviors.

For example, in the recommendation apparatus provided by an embodiment of the present disclosure, the weight determining unit further comprises a price coefficient determining unit and a cost coefficient determining unit. The price coefficient determining unit is configured to determine the price coefficient according to a price of a current object to be recommended, a minimum value of prices of all objects to be recommended, and a maximum value among prices of all the objects to be recommended. And the price coefficient is calculated as follows:

price coefficient=(price of current object to be recommended−minimum value among prices of all objects to be recommended)÷(maximum value among prices of all objects to be recommended−minimum value of prices of all objects to be recommended)+1.

The cost coefficient determining unit is configured to satisfy a relation between the cost coefficient and the price coefficient as follows: cost coefficient=1/price coefficient.

At least one embodiment of the present disclosure further provides a recommendation device, which includes: a processor; a memory which is used to store one or more computer program modules. The one or more computer program modules are configured to be executed by the processor, and the one or more computer program modules comprises instructions for performing the recommendation method provided by any embodiment of the present disclosure.

At least one embodiment of the present disclosure further provides a recommendation system, which includes: a terminal device, the recommendation apparatus provided by any embodiment of the present disclosure, a server and a business system database. The terminal device comprises a first terminal and a second terminal, and is configured to provide user behavior information related to at least one object to be recommended; the server is configured to store and analyze received data, and feed a processed result back to the terminal device; and the business system database is configured to store information of the at least one object to be recommended. The recommendation apparatus is arranged in the terminal device or in the server.

At least one embodiment of the present disclosure further provides a storage medium, which stores non-temporarily computer readable instructions that, when executed by a computer, cause the computer to perform instructions for the recommendation method provided by any embodiment of the present disclosure.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative to the disclosure.

FIG. 1 illustrates an exemplary system architecture to which a recommendation method provided by at least one embodiment of the present disclosure may be applied;

FIG. 2 illustrates an exemplary flowchart of a recommendation method according to at least one embodiment of the present disclosure;

FIG. 3 illustrates an exemplary flowchart of step S102 illustrated in FIG. 1;

FIG. 4A illustrates an exemplary structural block diagram of a recommendation apparatus according to at least one embodiment of the present disclosure;

FIG. 4B is a schematic diagram of a recommendation system provided by at least one embodiment of the present disclosure; and

FIG. 5 illustrates an exemplary structural block diagram of a device according to at least one embodiment of the present disclosure.

### DETAILED DESCRIPTION

In order to make objects, technical solutions and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by those of ordinary skill in the art to which the present disclosure belongs. The terms “first,” “second,” etc., which are used in the description and the claims of the present disclosure, are not intended to indicate any sequence, amount or importance, but used to distinguish various components. Similarly, the terms, such as “a,” “an,” “the,” or the like are not intended to denote limitation of quantity, but rather denote presence of at least one. The terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not limited to a physical connection or mechanical connection, but may include an electrical connection/coupling, directly or indirectly. The terms, “on,” “under,” “left,” “right,” or the like are only used to indicate relative position relationship, and when the position of the object which is described is changed, the relative position relationship may be changed accordingly.

With the development of social economy and the improvement of people's living standard, people's demand for artistic accomplishment, home art decoration or the like is constantly increasing, therefore digital photo frames are widely used. However, on one hand, for paintings, as an art form, different people have different tastes and impressions, and a vast number of painting resources make people confused, and hard to make a choose. On the other hand, behavior information of a user can reflect the user's interest preference for paintings and can be used as input information for a recommendation system. However, with the increase of a count of users and the increase of data information, it is difficult to process the increasing user behavior information data stored and calculated by a single computer.

At least one embodiment of the present disclosure provides a recommendation method, which includes: collecting user behavior information of a user for a painting; calculating a preference value of the user for the painting according to the user behavior information of the user for the painting, and constructing a preference matrix of the user for the painting; and acquiring a predicted preference value of the user for a painting with unknown preference based on the preference matrix, and implementing a painting recommendation according to the predicted preference value.

At least one embodiment of the present disclosure further provides a recommendation apparatus, a recommendation device, a recommendation system and a storage medium.

A recommendation method provided by the above embodiments of the present disclosure may calculate a preference value of a user for an object to be recommended according to user behavior information of the user for the object to be recommended, so that an object to be recommended may be recommended to a user according to the user's preference, thereby improving recommendation accuracy.

A recommendation method, recommendation apparatus, recommendation device, recommendation system and storage medium provided by some embodiments of the present disclosure will be described in further detail below with reference to the drawings and embodiments.

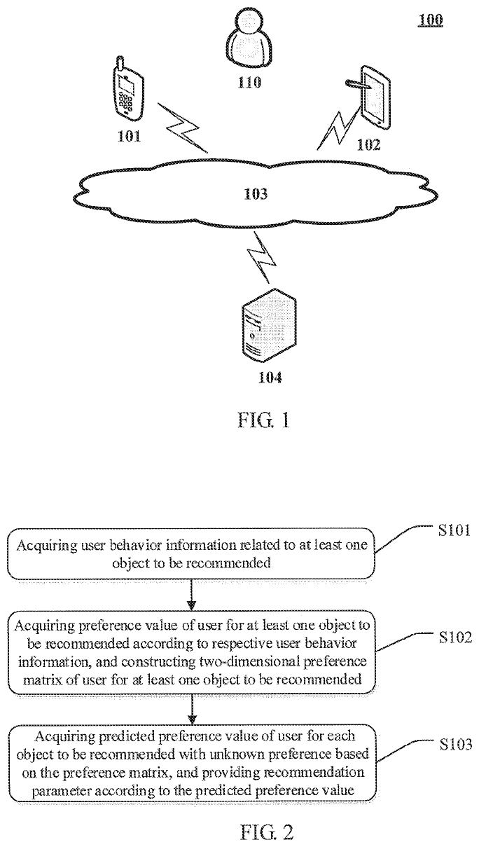

FIG. 1 illustrates an exemplary system architecture 100 to which a recommendation method provided by some embodiments of the present disclosure may be applied.

As illustrated in FIG. 1, a system architecture 100 may include a first terminal 101, a second terminal 102, a network 103, and a server 104. The network 103 is a medium for providing a communication link between the first terminal 101, the second terminal 102 and the server 104. The network 103 may include various connection types, such as wired, wireless communication links or fiber optic cables, etc.

A user 110 may interact with the server 104 through the network 103 using the first terminal 101 and the second terminal 102, so as to receive or send messages or the like. The first terminal 101 and the second terminal 102 may be installed with various applications of communication client, such as painting playing tools, painting preview software, painting purchase software, etc.

For example, the first terminal 101 may be various electronic devices, including but not limited to personal computers, smart phones, smart watches, tablet computers, personal digital assistants, etc. For example, the second terminal 102 is a digital photo frame.

The server 104 may be a server that provides various services. The server may process (e.g., store, analyze or the like) received data, and feed the processed result back to a terminal device (e.g., the first terminal 101 or the second terminal 102).

It should be noted that a painting recommendation method provided by the embodiments of the present disclosure may be performed by the first terminal 101 or the second terminal 102, or may be performed by the server 104. A painting recommendation apparatus may be arranged in the first terminal 101 or the second terminal 102, or may be arranged in the server 104. For example, when the first terminal 101 or the second terminal 102 performs the recommendation method, the server 104 may be informed of a recommendation result, and then the server 104 may recommend a saved related painting to the first terminal 101 or the second terminal 102.

It should be noted that the number of terminal devices (including the first terminal 101 and the second terminal 102), networks and servers in FIG. 1 is only schematic. According to requirement of implementation, there may be any number of terminal devices, networks and servers, and the embodiments of the present disclosure are not limited to this.

For example, in at least one embodiment of the present disclosure, an object to be recommended may be a digital rights product, for example, including paintings, videos or books, etc. It should be noted that the object to be recommended may also be articles such as clothes in online shopping. The embodiments of the present disclosure are not limited to this, and the corresponding recommendation method, recommendation apparatus, recommendation device and recommendation system are similar to the painting recommendation and will not be exhausted herein.

At least one embodiment of the present disclosure provides a recommendation method. For example, a painting recommendation method is an example of the recommendation method, and the painting recommendation method is taken as an example for illustrating. The embodiments of the present disclosure are not limited to this.

FIG. 2 illustrates an exemplary flowchart of a painting recommendation method provided by some embodiments of the present disclosure. As illustrated in FIG. 2, the painting recommendation method includes steps S101-S103. Next, the painting recommendation method provided by some embodiments of the present disclosure will be described in detail with reference to FIG. 2.

Step S101: acquiring user behavior information related to at least one object to be recommended.

Step S102: acquiring a preference value of a user for the at least one object to be recommended according to respective user behavior information, and constructing a preference matrix of the user for the at least one object to be recommended.

Step S103: acquiring a predicted preference value of the user for each object to be recommended with unknown preference based on the preference matrix, and providing a recommendation parameter according to the predicted preference value.

For example, the preference matrix may be a two-dimensional preference matrix, and the two-dimensional preference matrix is taken as an example for illustrating. The embodiments of the present disclosure are not limited to this.

For step S101, for example, the user behavior information includes single behavior information and combined behavior information, and also includes positive feedback behavior information and negative feedback behavior information, and other behavior information generated, directly or indirectly, for a painting. The embodiments of the present disclosure are not limited to this.

For example, the single behavior information includes behavior information generated by a user by operating a type of smart terminal such as mobile phones. The single behavior information has a small amount of data, and the preference is mostly positive feedback, i.e., degree information of like, while lack of negative feedback, i.e., degree information of dislike, so that the expressed information is not comprehensive enough. For example, the single behavior information may be acquired by accessing the first terminal 101 (e.g., a mobile phone). For example, single behavior information of the first terminal includes browsing behavior, searching behavior, purchasing behavior, non-purchasing behavior, sharing behavior, pushing behavior, etc. For example, the single behavior information may be acquired by accessing the second terminal 102 (e.g., a digital photo frame). For example, single behavior information of the second terminal includes playing behavior, etc.

For example, the combined behavior information includes behavior information generated by a user by operating at least two types of smart terminals. For example, the combined behavior information is acquired by accessing the first terminal 101 and the second terminal 102 respectively. For example, the combined behavior information includes purchasing behavior or non-purchasing behavior or the like implemented by the user after a painting, pushed from the first terminal 101 to the second terminal 102, is previewed on the second terminal 102 by the user.

For example, the combined behavior information includes behavior information of the first terminal 101 of a first type (e.g., a mobile phone terminal) (e.g., behavior such as browsing, searching, purchasing, and sharing a painting or pushing a painting to a digital photo frame), behavior information of the second terminal 102 of a second type (e.g., a digital photo frame terminal) (e.g., behavior such as previewing, playing a painting, etc.), and combined behavior information of the first terminal 101 and the second terminal 102 (e.g., a mobile phone and a digital photo frame) (e.g., behavior such as previewing, non-purchasing or purchasing after a painting pushed to the digital photo frame terminal). Therefore, the combined behavior information not only enriches positive feedback data, but also increases negative feedback data, so that recommendation results may be more accurate.

It should be noted that at least two types of smart terminals, rather than at least two smart terminal of the same type, are used to generate combined behavior information. Herein, different types of smart terminals means that different kinds of behavior information can be acquired from them, so as to achieve the purpose of enriching feedback data. In the embodiments of the present disclosure, the first terminal 101 as a mobile phone and the second terminal 102 as a digital photo frame are taken as an example for introducing. The above notes also apply to the following embodiments and detailed description thereof will be omitted here.

For example, in step S101, before acquiring user behavior information related to at least one object to be recommended, the method further includes collecting the user behavior information related to the at least one object to be recommended.

In some embodiments of the present disclosure, the accuracy of a recommendation algorithm depends greatly on the sparsity of data in a preference matrix for user-article. The rich behavior data in the combined behavior information reduces the number of zero elements in the matrix. For example, a zero element refers to an element in a matrix with an element value of zero, and in the embodiments of the present disclosure refers to an element with a preference value of zero. In addition, in the embodiments of the present disclosure, the negative feedback data is increased in the combined behavior information, for example, behaviors such as non-purchasing or purchasing after browsing, thereby improving the accuracy of recommendation results.

For example, an acquisition unit may be provided, and user behavior information related to at least one object to be recommended may be acquired through the acquisition unit. For example, the acquisition unit may also be implemented by a central processing unit (CPU), an image processing unit (GPU), a tensor processing unit (TPU), a field programmable gate array (FPGA) or other forms of processing units having data processing capability and/or instruction execution capability and corresponding computer instructions. The processing unit may be a general-purpose processor or a special-purpose processor, and may be a processor based on X86 or ARM architecture, etc.

For step S102, based on a user behavior information set in step S101, a preference value of a user for a painting is calculated according to the user behavior information of the user for the painting. Each preference value is taken as a matrix element to construct a two-dimensional preference matrix W of the user for the painting. For example, the two-dimensional preference matrix W may be represented as:

W≈PQ^{T} (6)

where, P is a m×k matrix, Q^{T} is a k×n matrix, m is a count of users, n is a count of paintings, k is an optional super parameter, and m, n, k are all integers greater than or equal to 1.

It should be noted that a calculation method of the preference value of the user for the painting is described in detail below and will not be repeated here.

For example, a matrix construction unit may be provided, and a preference matrix of a user for a painting may be constructed by the matrix construction unit. For example, the matrix construction unit may also be implemented by a central processing unit (CPU), an image processing unit (GPU), a tensor processing unit (TPU), a field programmable gate array (FPGA) or other forms of processing units having data processing capability and/or instruction execution capability and corresponding computer instructions.

For step S103, the two-dimensional preference matrix W is decomposed by a collaborative filtering method, so as to calculate predicted preference values of the user for paintings with unknown preference, and the predicted preference values are sorted by size, and a plurality of paintings with the predicted preference values larger than a set value or with larger predicted preference values are recommended to the user. It should be noted that the matrix decomposition and the calculation of the predicted preference values of the user for paintings with unknown preference are described in detail below and will not be repeated here.

For example, in some embodiments of the present disclosure, a collection of user behavior information includes at least one of:

acquiring single behavior information by accessing a mobile phone terminal, in which single behavior information of the mobile phone terminal comprises browsing behavior, searching behavior, purchasing behavior, non-purchasing behavior, sharing behavior and pushing behavior; acquiring single behavior information by accessing a digital photo frame terminal, in which single behavior information of the digital photo frame terminal comprises playing behavior; acquiring combined behavior information by accessing the mobile phone terminal and the digital photo frame terminal respectively, in which the combined behavior information comprises purchasing behavior or non-purchasing behavior after a painting, pushed from the mobile phone terminal to the digital photo frame terminal, is previewed on the digital photo frame terminal.

Some embodiments of the present disclosure make recommendations based on a variety of behaviors of a user for a painting, thereby making the accuracy of recommendation results higher. These behaviors include behavior information on the mobile phone terminal, such as browsing, searching, purchasing, sharing and pushing paintings to the digital photo frame, etc., further include behavior information on the digital photo frame terminal, such as previewing, playing paintings, etc., and combined behavior information on the mobile phone terminal and the digital photo frame terminal, such as pushing to the digital photo frame terminal and previewing but not purchasing on the mobile phone terminal, etc.

For example, an output unit may be provided, through which a predicted preference value of a user for a painting with unknown preference is acquired, and a painting recommendation is implemented according to the predicted preference value. For example, the output unit may also be implemented by a central processing unit (CPU), an image processing unit (GPU), a tensor processing unit (TPU), a field programmable gate array (FPGA) or other forms of processing units having data processing capability and/or instruction execution capability and corresponding computer instructions.

For example, FIG. 3 illustrates an exemplary flowchart of step S102 illustrated in FIG. 1. As illustrated in FIG. 3, step S102 includes steps S201 and S202. A painting recommendation method provided by some embodiments of the present disclosure will be described in detail below with reference to FIG. 3.

Step S201: calculating a preference value of a user i for an object j to be recommended by weighting user behavior information of the user i for the object j to be recommended.

For example, a calculation method of a preference value wᵢⱼ of the user i for the painting j is as follows:

wᵢⱼ=Σₖ₌₁^{L}aₖrₖ (1)

where aₖ is a weight of a kth type of user behavior; rₖ represents whether the kth type of user behavior occurs or not, if occurs, rₖ takes 1, otherwise, rₖ takes 0; 1≤k≤L, L represents a count of behavior types, L is an integer greater than 1, and i and j are all integers greater than or equal to 1.

For example, 1≤i≤m, 1≤j≤n.

Specifically, in a case where browsing behavior and purchasing behavior of a user 1 for a painting 2 occur, a preference value of the user 1 for the painting 2 may be generated by adding a weight of the browsing behavior to a weight of the purchasing behavior, and so on.

For example, for different behavior types, the weight aₖ of different behavior types may be determined according to a count of behaviors, a price coefficient and a cost coefficient. For example, each of the behavior types is set with a corresponding single behavior weight. It should be noted that a specific method for acquiring the weight aₖ is described in detail below and will not be repeated here.

Step S202: constructing a preference matrix of a user for a painting.

For example, the preference value wᵢⱼ corresponding to the collected user behavior information acquired in step S201 is taken as a matrix element for constructing a two-dimensional preference matrix W.

For example, the constructed preference matrix may include a preference value of the user 1 for the painting 2, but may not include a preference value of the user 1 for a painting 4. Therefore, how to calculate a preference value of a user for a painting with unknown preference in the preference matrix will be described below based on step S103.

For example, after a preference matrix of a user for paintings is constructed, preference values of the user for paintings with unknown preference in the matrix may be calculated through the existing preference values wᵢⱼ in the matrix.

For example, the above formula (6) is matrix decomposed by a collaborative filtering method, i.e., p and q satisfying the following formula are solved by using the known preference values wᵢⱼ in the preference matrix W:

min Σ(wᵢⱼ−pᵢqⱼ^{T})²+λ(∥pᵢ∥²+∥qⱼ∥²) (2)

where λ is a regularization parameter, and p and q are set as row vectors of P and Q respectively.

For example, the following formulas may be obtained by iteratively solving formula (2) through a gradient descent method:

qⱼ=qⱼ+α((wᵢⱼ−pᵢqⱼ^{T})pᵢ−λqⱼ) (3)

pᵢ=pᵢ+α((wᵢⱼ−pᵢqⱼ^{T})qⱼ−λpᵢ) (4)

where α is a learning rate.

Then, prediction preference wᵢⱼ^{P} of the user i for the painting j may be obtained by the following formula:

wᵢⱼ^{P}=pᵢqⱼ^{T} (5)

Finally, predicted preference values of the user i for all paintings with unknown preference are obtained by using formula (5), and sorted by size. Top N paintings with larger preference values or paintings with preference values greater than a set value are recommended to the user. For example, N is an integer greater than or equal to 1. For example, N may be equal to 10. It should be noted that a value of N may be determined according to actual requirements, and the embodiments of the present disclosure are not limited to this.

For example, in some embodiments of the present disclosure, for step S201, weights aₖ of different behavior types are determined according to a count of behaviors, a price coefficient and a cost coefficient, for different behavior types.

For example, when a behavior type is a purchasing behavior, a weight of the purchasing behavior is determined according to a count of behaviors, a price coefficient and a cost coefficient, and a calculation method of the weight of the purchasing behavior is as follows:

weight=single behavior weight×count of behaviors×price coefficient.

For example, when the behavior type is a non-purchasing behavior, a weight of the non-purchasing is calculated as follows:

weight=single behavior weight×cost coefficient.

For example, when it comes to other behavior types, for example, the other behavior types include browsing, searching, etc., a weight of the other behavior types is calculated as follows:

weight=single behavior weight×count of behaviors.

For example, in order to better reflect a preference degree of a user for a painting, a single behavior weight is set for each of behavior types of a user.

For example, a single behavior weight for browsing behavior is 0.1, a single behavior weight for searching behavior is 0.2, a single behavior weight for purchasing behavior is 1, and a single behavior weight for non-purchasing behavior is −0.5, these values may be set according to actual requirements, and the embodiments of the present disclosure are not limited to this.

It should be noted that when the other behavior type of a user is playing behavior, its single behavior weight may be understood as single behavior weight×playing time weight, because playing time also reflects preference degree of the user for a painting. For example, a single behavior weight for the playing behavior is 1, and the playing time weight is related to the playing time. For example, when the playing time is more than 7 days, the playing time weight is 2; when the playing time is between 1 day and 7 days, the playing time weight is 1.5; when the playing time is less than 1 day, the playing time weight is 1, and a corresponding relationship between the playing time weight and the playing time may depend on actual situations, and the embodiments of the present disclosure are not limited to this.

For example, when the other behavior type of a user is a sharing behavior, a count of behaviors may be regarded as 1, and a single behavior weight for the sharing behavior is, for example, 3, but the embodiments of the present disclosure are not limited to this.

For example, in some embodiments of the present disclosure, a price coefficient and a cost coefficient are calculated as follows.

For example, the price coefficient is determined according to a price of a current painting, a minimum value among prices of all paintings, and a maximum value among prices of all the paintings. The price coefficient is as follows:

price coefficient=(price of current painting−minimum value among prices of all paintings)÷(maximum value among prices of all paintings−minimum value of prices of all paintings)+1.

For example, a relationship between the cost coefficient and the price coefficient is as follows:

cost coefficient=1/price coefficient.

In the above embodiments of the present disclosure, in addition to considering user behavior information of a user for a painting, a price of the painting is also taken as a factor for calculating a preference value of the user for the painting, so that paintings may be more accurately recommended.

It should be noted that a flow of the painting recommendation method provided by some embodiments of the present disclosure may include more or fewer operations, these operations may be performed sequentially or in parallel. Although the flow of the painting recommendation method described above includes a plurality of operations occurring in a specific order, it should be clearly understood that the order of the plurality of operations is not limited. The painting recommendation method described above may be performed once or multiple times according to predetermined conditions.

The painting recommendation method provided in the above embodiments of the present disclosure may calculate a preference value of a user for a painting according to behavior information of the user for the painting, so that paintings may be recommended to the user according to the user's preference, and the recommendation accuracy is improved.

At least one embodiment of the present disclosure provides a recommendation apparatus. For example, a painting recommendation apparatus is an example of the recommendation apparatus, and the painting recommendation apparatus is taken as an example for illustrating below, and the embodiments of the present disclosure are not limited to this.

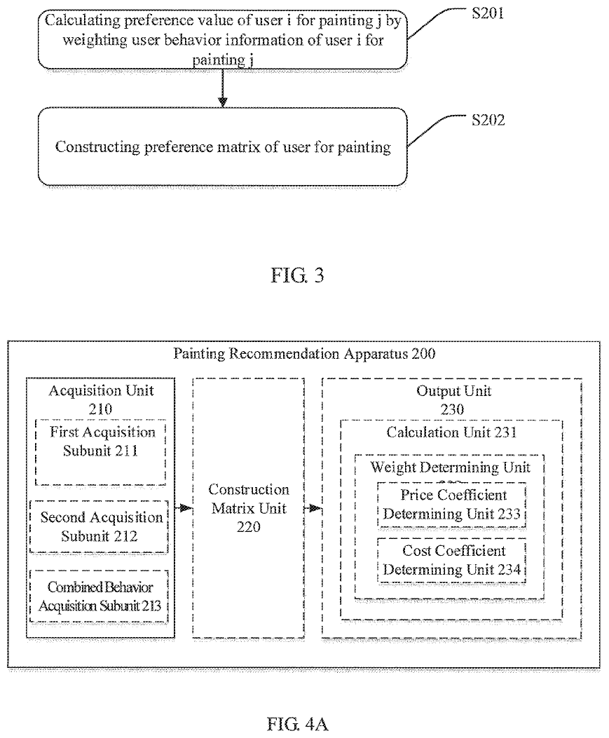

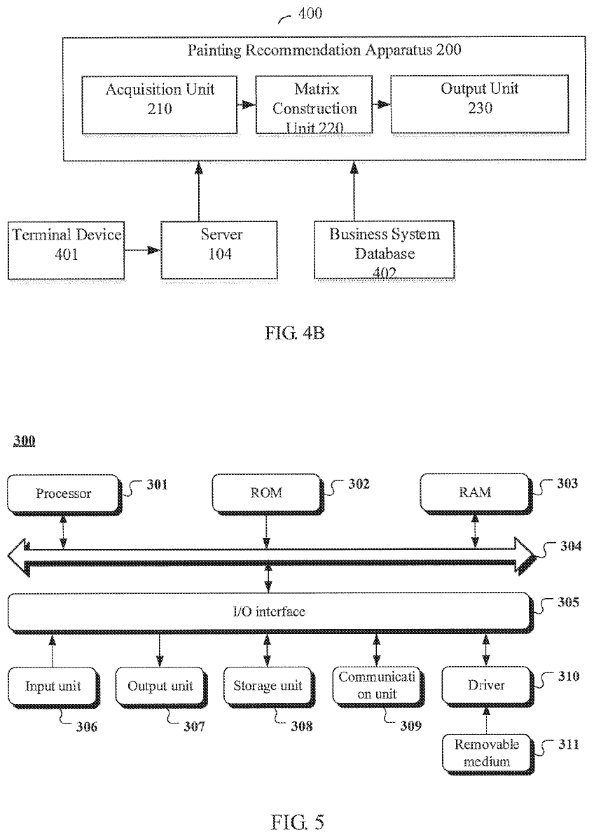

FIG. 4A illustrates an exemplary structural block diagram of a painting recommendation apparatus 200 according to some embodiments of the present disclosure. As illustrated in FIG. 4A, the painting recommendation apparatus 200 includes an acquisition unit 210, a matrix construction unit 220, and an output unit 230. For example, these units may be implemented in forms of hardware modules, for example, circuits, CPU, FPGA and etc., or software modules and any combination thereof.

For example, the acquisition unit 210 is configured to acquire user behavior information related to at least one object to be recommended. For example, user behavior information includes single behavior information and combined behavior information. For example, the acquisition unit 210 may implement step S101, and its specific implementation method may refer to the relevant description of step S101, which will not be repeated here.

The matrix construction unit 220 is configured to calculate a preference value of a user for a painting according to each user behavior information, and construct a preference matrix of the user for the painting. For example, the matrix construction unit 220 may implement step S102, and its specific implementation method may refer to the relevant description of step S102, which will not be described here.

The output unit 230 is configured to acquire a predicted preference value of a user for a painting with unknown preference based on a preference matrix, and to implement painting recommendation according to the predicted preference value. For example, the output unit 230 may implement step S103, and its specific implementation method may refer to the relevant description of step S103, which will not be repeated here.

Please refer to the painting recommendation method illustrated in FIG. 2 for the working principle of the painting recommendation apparatus 200, which will not be repeated here.

For example, in some embodiments, as illustrated in FIG. 4A, the acquisition unit 210 includes a first acquisition subunit 211, a second acquisition subunit 212, and a combined behavior acquisition subunit 213.

The first acquisition subunit 211 is configured to acquire single behavior information by accessing a first terminal. For example, single behavior information of the first terminal includes a browsing behavior, a searching behavior, a purchasing behavior, a non-purchasing behavior, a sharing behavior, a pushing behavior, etc.

The second acquisition subunit 212 is configured to acquire single behavior information by accessing a second terminal. For example, single behavior information of the second terminal includes a playing behavior.

The combined behavior acquisition subunit 213 is configured to acquire combined behavior information by accessing the first terminal and the second terminal respectively. For example, the combined behavior information includes a non-purchasing behavior or a purchasing behavior implemented after a painting, pushed from the first terminal to the second terminal, is previewed on the second terminal.

For example, in some embodiments, as illustrated in FIG. 4A, the output unit 230 includes a calculation unit 231.

The calculation unit 231 is configured to weight and calculate user behavior information of a user i for a painting j, so as to calculate a preference value of the user i for the painting j. For example, a calculation method of a preference value of the user i for the object j to be recommended is as follows:

wᵢⱼ=Σₖ₌₁^{L}aₖrₖ (1)

where aₖ is a weight of a kth type of user behavior; rₖ represents whether the kth type of user behavior occurs or not, if occurs, rₖ takes 1, otherwise, rₖ takes 0; 1≤k≤L, L is a count of behavior types, L is an integer greater than 1, and i and j are both integers greater than or equal to 1.

For example, in some embodiments, the calculation unit includes a weight determining unit 232.

The weight determining unit 232 is configured to determine weights, for different behavior types, according to a single behavior weight, a count of behaviors, a price coefficient and a cost coefficient. For example, each of behavior types is set with a corresponding single behavior weight.

For example, when a behavior type is a purchasing behavior, a weight of the purchasing behavior is calculated as follows:

weight=single behavior weight×count of behaviors×price coefficient.

For example, when the behavior type is a non-purchasing behavior, a weight of the non-purchasing is calculated as follows:

weight=single behavior weight×cost coefficient.

For example, when it comes to other behavior types, a weight of the other behavior types is calculated as follows:

weight=single behavior weight×count of behaviors.

For example, in some embodiments, the weight determining unit further includes a price coefficient determining unit 233 and a cost coefficient determining unit 234.

The price coefficient determining unit 233 is configured to determine a price coefficient according to a price of a current painting, a minimum value among prices of all paintings, and a maximum value among prices of all the paintings.

For example, the price coefficient is calculated as follows:

price coefficient=(price of current painting−minimum value among prices of all paintings)÷(maximum value among prices of all paintings−minimum value of prices of all paintings)+1.

The cost coefficient determining unit 234 is configured to make a relationship between the cost coefficient and the price coefficient satisfy: cost coefficient=1/price coefficient.

It should be noted that in the embodiments of the present disclosure, more or fewer circuits or units may be included, and connection relationships between the various circuits or units are not limited and may be determined according to actual requirements. The specific configuration of each circuit is not limited, and may be composed of analog devices, digital chips, or other applicable manners according to circuit principles.

The technical effect of the painting recommendation apparatus 200 provided in the embodiments of the present disclosure may refer to the technical effect of the painting recommendation method provided in some embodiments of the present disclosure and will not be repeated here.

At least one embodiment of the present disclosure provides a recommendation system. For example, a painting recommendation system is an example of the recommendation system, and the painting recommendation system is taken as an example for illustrating below, and the embodiments of the present disclosure are not limited to this.

FIG. 4B is a schematic diagram of a painting recommendation system provided by some embodiments of the present disclosure. As illustrated in FIG. 4B, a painting recommendation system 400 includes a terminal device 401, a painting recommendation apparatus 200 illustrated in FIG. 4A, a server 104 illustrated in FIG. 1, and a business system database 402.

For example, the terminal device 401 includes a first terminal 101 (e.g., a mobile phone) and a second terminal (e.g., a digital photo frame) illustrated in FIG. 1, but the embodiments of the present disclosure are not limited to this. For example, the terminal device 401 is configured to provide user behavior information of a user for a painting. For example, the user behavior information includes single behavior information and combined behavior information. For details, please refer to the overview in the painting recommendation method, which will not be repeated here. For example, the first terminal 101 may be various electronic devices, including but not limited to personal computers, smart phones, smart watches, tablet computers, personal digital assistants, and the like. For example, the second terminal 102 is a digital photo frame.

For example, user behavior information provided by the terminal device 401 is transmitted to the server 104 for storing and preprocessing. Because the need to support a large number of users and to record behavior information of mobile phone APP and digital photo frame APP of each of the users, hadoop platform supporting big data storage may be adopted to store user behavior information of users in a distributed manner. For example, a storage apparatus (not illustrated in the figure) may be separately arranged, and the embodiments of the present disclosure are not limited to this.

For example, the server 104 may be a server that provides various services. The server is configured to process (e.g., store, analyze, etc.) received data and feed the processed result back to the terminal device 401.

For example, a user may interact with the server 104 through the network 103 (as illustrated in FIG. 1) using the terminal device 401 to receive or send messages, etc. The terminal device 401 may be installed with various applications of communication client (not illustrated in the figure), such as painting playing tools, painting preview software, painting purchase software, etc.

For example, the business system database 402 is configured to store information of paintings. For example, information of a painting includes attribute information of the painting, such as author, name, category, introduction, price, etc.

For example, when the matrix construction unit 220 determines a preference matrix, the acquisition unit 210 may read and transmit the stored user behavior information from the storage apparatus and the information of the painting from the business system database 402 to the matrix construction unit 220, so as to determine the preference matrix, so that a preference matrix of a user for a painting simultaneously takes into account factors such as single behavior information, combined behavior information, painting price data, and the like, thereby improving the accuracy of painting recommendation. Finally, a painting recommended to the user is output by the output unit 230.

For example, the painting recommendation apparatus 200 may be arranged in the terminal device 401 or in the server 104. That is, the painting recommendation method provided by the embodiments of the present disclosure may be performed by the terminal device 401 or the server 104.

For example, when the terminal device 401 performs the painting recommendation method, the server 104 may be informed of a recommendation result, and then the server 104 may recommend a saved related painting to the terminal device 401, and the embodiments of the present disclosure are not limited to this.

The technical effects of the painting recommendation system 400 provided in the embodiments of the present disclosure may refer to the technical effects of the painting recommendation method provided in some embodiments of the present disclosure and will not be repeated here.

At least one embodiment of the present disclosure provides a recommendation device. For example, a painting recommendation device is an example of the recommendation device, and the painting recommendation device is taken as an example for illustrating below, and the embodiments of the present disclosure are not limited to this.

FIG. 5 illustrates a schematic structural diagram of a computer system applicable to implementing the terminal device or the server provided by some embodiments of the present disclosure.

As illustrated in FIG. 5, some embodiments of the present disclosure also provide a painting recommendation device 300, which includes a processor 301, a memory (not illustrated in the figure, for example, including a read only memory (ROM) 302, a random access memory (RAM) 303, and a storage unit 308).

For example, the processor 301 may be a central processing unit (CPU), an image processing unit (GPU), or other forms of processing units having data processing capability and/or instruction execution capability, may be a general-purpose processor or a special-purpose processor, and may control other components in the painting recommendation device 300 to perform desired functions.

For example, the processor 301 may perform various appropriate actions and processes according to computer program modules stored in the read only memory (ROM) 302 or computer program modules loaded into the random access memory (RAM) 303 from the storage unit 308. In the RAM 303, various computer program modules and data required for operations of the system 300 are also stored. The processor 301, ROM 302, and RAM 303 are connected to each other through a bus 304.

For example, the memory is used to store one or more computer program modules, and the one or more computer program modules are configured to be executed by the processor 301. For example, the one or more computer program modules include instructions for implementing the painting recommendation method provided by any embodiment of the present disclosure. A computer program product may include various forms of computer readable storage media, such as volatile memory and/or nonvolatile memory. The volatile memory may include, for example, random access memory (RAM) and/or cache, etc. The nonvolatile memory may include, for example, read only memory (ROM), hard disk, flash memory, etc. One or more computer program instructions may be stored on the computer readable storage medium, and the processor 210 may execute the program instructions to implement the functions in the embodiments of the present disclosure (implemented by the processor 210) and/or other desired functions, such as a painting recommendation method, etc. The computer readable storage medium may also store various application programs and various data, such as a preference matrix and various data used and/or generated by the application programs.

For example, the painting recommendation device further includes an input/output (I/O) interface 305, which is also connected to the bus 304. For example, the bus 304 may be a common serial or parallel communication bus or the like, and the embodiments of the present disclosure are not limited to this.

For example, the painting recommendation device 300 further includes the following components all connected to the I/O interface 305: an input unit 306 including a keyboard, a mouse, and the like; an output unit 307 including such as a cathode ray tube (CRT), a liquid crystal display (LCD), and a speaker, etc.; a storage unit 308 including a hard disk or the like; and a communication unit 309 including a network interface card such as a LAN card, a modem, etc.

For example, the painting recommendation device 300 further includes a communication unit 309, a driver 310, and a removable medium 311. The communication unit 309 performs communication processing via a network such as the Internet. The driver 310 is also connected to the I/O interface 305 as needed. The removable medium 311, such as magnetic disk, optical disk, magneto-optical disk, semiconductor memory, etc., are installed on the driver 310 as needed, so that computer programs read therefrom may be installed into the storage unit 308 as needed.

For example, according to the embodiments of the present disclosure, the process described in FIG. 1 may be implemented as computer software programs. For example, the embodiments of the present disclosure include a computer program product, which includes a computer program tangibly embodied on a machine readable medium, the computer program including program code for performing a painting recommendation method. In such embodiments, the computer program may be downloaded and installed from the network through the communication unit 309, and/or installed from the removable medium 311.

The architectures, functions and operations of possible implementations of the system, method and computer program product according to the embodiments of the present disclosure are illustrated in FIGS. 1-5. In this regard, each block in the flowchart or block diagram may represent a module, program segment, or portion of code that contains one or more executable instructions for implementing the specified logical functions. It should also be noted that in some alternative implementations, the functions noted in the blocks may also occur in a different order than that noted in the figures. For example, two blocks illustrated in succession may actually be executed substantially in parallel, and they may sometimes be executed in the reverse order, depending on the functions involved. It should also be noted that each block in the block diagram and/or flowchart, and combinations of blocks in the block diagram and/or flowchart, may be implemented by a dedicated hardware-based system that performs specified functions or operations, or may be implemented by a combination of dedicated hardware and computer instructions.

It should be noted that, for clarity and conciseness, the embodiments of the present disclosure do not give all components of the painting recommendation device 300. In order to implement necessary functions of the painting recommendation device 300, those skilled in the art may provide and set other components not illustrated according to specific requirements, and the embodiments of the present disclosure are not limited to this.

The technical effects of the painting recommendation device 300 provided by the embodiments of the present disclosure may refer to the technical effects of the painting recommendation method provided in some embodiments of the present disclosure and will not be repeated here.

For example, some embodiments of the present disclosure also provide a storage medium. For example, the storage medium stores non-temporarily computer readable instructions, and when the non-temporary computer readable instructions are executed by a computer (including a processor), the painting recommendation method provided by any embodiment of the present disclosure may be performed.

For example, the storage medium may be a storage medium included in the apparatus provided in the above embodiments; and may also be a storage medium that exists separately and is not assembled into a device. The storage medium stores one or more computer programs which are used by one or more processors to perform the painting recommendation method provided by the embodiments of the present disclosure.

For example, the storage medium may be any combination of one or more computer readable storage media. For example, one computer readable storage medium contains computer readable program code for constructing a preference matrix of a user for paintings, and another computer readable storage medium contains computer readable program code for acquiring predicted preference values of the user for paintings with unknown preference. For example, when the program code is read by a computer, the computer may execute the program code stored in the computer storage medium for performing, for example, the painting recommendation method provided by any embodiment of the present disclosure.

For example, the storage medium may include a memory card of a smart phone, a storage component of a tablet computer, a hard disk of a personal computer, random access memory (RAM), read only memory (ROM), erasable programmable read-only memory (EPROM), portable compact disk read-only memory (CD-ROM), flash memory, or any combination of the above storage media, or may be other applicable storage media.

The above description is only an illustration of the preferred embodiments of the present disclosure and the applied technical principles. Those skilled in the art should understand that the scope of the invention referred to in this disclosure is not limited to the technical solutions formed by a specific combination of the above technical features, but also covers other technical solutions formed by any combination of the above technical features or their equivalent features without departing from the inventive concept, for example, the technical solutions formed by replacing the above features with (but not limited to) technical features having similar functions disclosed in the present disclosure.

For the present disclosure, the following statements should be noted:

(1) The accompanying drawings involve only the structure(s) in connection with the embodiment(s) of the present disclosure, and for other structure(s), reference can be made to common design(s).

(2) The embodiments of the present disclosure and features in the embodiments may be combined with each other to obtain new embodiments if they do not conflict with each other.

What are described above is related to the specific embodiments of the disclosure only and not limitative to the scope of the disclosure, and the scopes of the disclosure are defined by the accompanying claims.

1: A recommendation method, comprising:
acquiring user behavior information related to at least one object to be recommended;
acquiring a preference value of a user for the at least one object to be recommended according to respective user behavior information, and constructing a preference matrix of the user for the at least one object to be recommended; and
acquiring a predicted preference value of the user for each object to be recommended with unknown preference based on the preference matrix, and providing a recommendation parameter according to the predicted preference value.

2: The recommendation method according to claim 1, wherein the user behavior information comprises single behavior information or combined behavior information;
the single behavior information comprises behavior information generated by the user by operating one type of smart terminal; and
the combined behavior information comprises behavior information generated by the user by operating at least two types of smart terminals.

3: The recommendation method according to claim 1, wherein the preference matrix is decomposed by a collaborative filtering method, so as to output the predicted preference value of the user for each object to be recommended with unknown preference.

4: The recommendation method according to claim 1, wherein acquiring the user behavior information related to the at least one object to be recommended, comprises:
acquiring single behavior information from a first terminal, wherein single behavior information of the first terminal comprises browsing behaviors, searching behaviors, purchasing behaviors, non-purchasing behaviors, sharing behaviors and pushing behaviors;
acquiring single behavior information from a second terminal, wherein single behavior information of the second terminal comprises playing behaviors; and
acquiring combined behavior information from the first terminal and the second terminal respectively, wherein the combined behavior information comprises purchasing behaviors or non-purchasing behaviors implemented by the user after an object to be recommended, which is pushed from the first terminal to the second terminal, is previewed on the second terminal by the user.

5: The recommendation method according to claim 1, wherein acquiring the preference value of the user for the at least one object to be recommended according to respective user behavior information, and constructing the preference matrix of the user for the at least one object to be recommended, comprise:
calculating a preference value of a user i for an object j to be recommended by weighting user behavior information of the user i for the object j to be recommended, wherein a calculation method of a preference value wᵢⱼ of the user i for the object j to be recommended is as follows:
wᵢⱼ=Σₖ₌₁^{L}aₖrₖ (1)
wherein aₖ is a weight of a k^{th} type of user behavior; rₖ represents whether the k^{th} type of user behavior occurs or not, if occurs, rₖ takes 1, otherwise, rₖ takes 0; where 1≤k≤L, L is an integer greater than 1 and represents a count of behavior types, and i and j are both integers greater than or equal to 1.

6: The recommendation method according to claim 5, wherein, for different behavior types, weights of the different behavior types are determined according to a count of behaviors, a price coefficient and a cost coefficient, and
wherein each of the behavior types is set with a corresponding single behavior weight.

7: The recommendation method according to claim 6, wherein,
when a behavior type belongs to a purchasing behavior, a weight of the purchasing behavior is calculated as follows:
weight=single behavior weight×count of behaviors×price coefficient;
when the behavior type belongs to a non-purchasing behavior, a weight of the non-purchasing is calculated as follows:
weight=single behavior weight×cost coefficient; and
when the behavior belongs to other behavior types, a weight of the other behavior types is calculated as follows:
weight=single behavior weight×count of behaviors.

8: The recommendation method according to claim 6, wherein the price coefficient is determined according to a price of a current object to be recommended, a minimum value among prices of all objects to be recommended, and a maximum value among prices of all the objects to be recommended; and
wherein the price coefficient is calculated as follows:
price coefficient=(price of current object to be recommended−minimum value among prices of all objects to be recommended)÷(maximum value among prices of all objects to be recommended−minimum value among prices of all objects to be recommended)+1.

9: The recommendation method according to claim 8, wherein a relationship between the cost coefficient and the price coefficient is as follows:
cost coefficient=1/price coefficient.

10: The recommendation method according to claim 5, wherein acquiring a predicted preference value of the user for an object to be recommended with unknown preference based on the preference matrix and providing the recommendation parameter according to the predicted preference value, comprises:
sorting predicted preference values of the user i for all objects to be recommended with unknown preference, and recommending top N objects to be recommended with the predicted preference values sorted from large to small or objects to be recommended with the predicted preference values larger than a set value to the user i, wherein N is an integer greater than or equal to 1.

11: The recommendation method according to claim 1, wherein the preference matrix is a two-dimensional preference matrix.

12: The recommendation method according to claim 1, wherein the object to be recommended comprises a painting.

13: A recommendation apparatus, comprising:
an acquisition unit, configured to acquire user behavior information related to at least one object to be recommended;
a matrix construction unit, configured to calculate a preference value of a user for the at least one object to be recommended according to respective user behavior information, and construct a preference matrix of the user for the at least one object to be recommended; and
an output unit, configured to acquire a predicted preference value of the user for each object to be recommended with unknown preference based on the preference matrix, and provide a recommendation parameter according to the predicted preference value.

14: The recommendation apparatus according to claim 13, wherein the acquisition unit comprises:
a first acquisition subunit, configured to acquire single behavior information from a first terminal, wherein the single behavior information of the first terminal comprises browsing behaviors, searching behaviors, purchasing behaviors, non-purchasing behaviors, sharing behaviors and pushing behaviors;
a second acquisition subunit, configured to acquire single behavior information from a second terminal, wherein the single behavior information of the second terminal comprises playing behaviors; and
a combined behavior acquisition subunit, configured to acquire combined behavior information from the first terminal and the second terminal respectively, wherein the combined behavior information comprises non-purchasing behaviors or purchasing behaviors implemented by the user after an object to be recommended, which is pushed from the first terminal to the second terminal, is previewed on the second terminal by the user.

15: The recommendation apparatus according to claim 13, wherein the output unit comprises:
a calculation unit, configured to calculate a preference value of the user i for the object j to be recommended by weighting user behavior information of a user i for an object j to be recommended, wherein the preference value wᵢⱼ of the user i for the object j to be recommended is calculated as follows:
$${w}_{ij} = {\sum }_{k = 1}^{L} {a}_{k} {r}_{k} \qquad ( 1 )$$
wherein aₖ is a weight of a k^{th} type of user behavior; rₖ represents whether the k^{th} type of user behavior occurs or not, if occurs, rₖ takes 1, otherwise, rₖ takes 0, where 1≤k≤L, L is an integer greater than 1 and represents a count of behavior types, and i and j are both integers greater than or equal to 1.

16: The recommendation apparatus according to claim 15, wherein the calculation unit comprises:
a weight determining unit, configured to, for different behavior types, determine weights of the different behavior types according to a single behavior weight, a count of behaviors, a price coefficient and a cost coefficient, and
wherein each of the behavior types is set with a corresponding single behavior weight.

17: The recommendation apparatus according to claim 16, wherein, when a behavior type is a purchasing behavior, a weight of the purchasing behavior is calculated as follows:
weight=single behavior weight×count of behaviors×price coefficient;
when the behavior type is a non-purchasing behavior, a weight of the non-purchasing is calculated as follows:
weight=single behavior weight×cost coefficient; and
as for other behavior types, a weight of the other behavior types is calculated as follows:
weight=single behavior weight×count of behaviors.

18: The recommendation apparatus according to claim 16, wherein the weight determining unit further comprises:
a price coefficient determining unit, configured to determine the price coefficient according to a price of a current object to be recommended, a minimum value among prices of all objects to be recommended, and a maximum value among prices of all objects to be recommended;
wherein the price coefficient is calculated as: price coefficient=(price of current object to be recommended−minimum value among prices of all objects to be recommended)÷(maximum value among prices of all objects to be recommended−minimum value among prices of all objects to be recommended)+1; and
a cost coefficient determining unit, configured to make a relation between the cost coefficient and the price coefficient satisfy: cost coefficient=1/price coefficient.

19: A recommendation device, comprising:
a processor;
a memory, used to store one or more computer program modules,
wherein the one or more computer program modules are configured to be executed by the processor, and the one or more computer program modules comprises instructions for performing the recommendation method according to claim 1.

20: A recommendation system, comprising a terminal device, the recommendation apparatus according to claim 13, a server and a business system database, wherein,
the terminal device includes a first terminal and a second terminal, and is configured to provide user behavior information related to at least one object to be recommended;
the server is configured to process received data, and feedback the processed result to the terminal device, wherein to process received data at least includes to store and to analyze the data; and
the business system database is configured to store information of the at least one object to be recommended; and
wherein the recommendation apparatus is arranged in the terminal device or in the server.

21. (canceled)
